(19) United States
(12) Patent Application Publication
(10) Pub. No.: US 2003/0206172 A1
(43) Pub. Date: Nov. 6, 2003

(54) System and method for the asynchronous collection and management of video data

(75) Inventor: Bruce Alexander, Poulsbo, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Vigilos, Inc.

(21) Appl. No.: 10/377,914

(22) Filed: Feb. 28, 2003

Related U.S. Application Data
(60) Provisional application No. 60/361,885, filed on Mar. 5, 2002.

(51) Int. Cl. G06F 15/167; G06F 12/02

(52) U.S. Cl. 345/541; 345/543

(57) ABSTRACT

A system and method for asynchronously processing video images are provided. A video processing computing device includes one or more video capture boards in communication with a number of image capture devices, such as video cameras. The video image processing computing device includes a video collection application that is operable to instruct the video capture board to acquire video data and store the data in a shared memory area. The video processing computing device also includes a video processing application that is operable to acquire the stored video from the shared memory area and process the video data. By utilizing a shared memory area, the video collection application and the video processing application can process data asynchronously.

### CROSS-REFERENCE TO RELATED APPLICATION

This application claims the benefit of U.S. Provisional Application No. 60/361,885 entitled SYSTEM AND METHOD FOR ASYNCHRONOUS COLLECTION AND MANAGEMENT OF VIDEO DATA and filed on Mar. 5, 2002. U.S. application Ser. No. 60/361,885 is incorporated by reference herein.

### FIELD OF THE INVENTION

The present invention relates generally to computer hardware and software, and in particular, to a system and method for managing and processing video data.

### BACKGROUND OF THE INVENTION

Video capture boards are computer hardware devices used to capture or “grab” video data from a camera, or other image capture devices. More specifically, video capture boards are used to acquire analog video signals from a camera, convert the captured analog video signals into a digitally formatted signal, and store the resulting digital video signal into memory. The digital video signal can be stored in local memory resident on the video capture board or, alternatively, transferred to a computer's main memory. In turn, software programs on the computer's central processor can retrieve the processed digital video signals for a variety of uses. For example, security software programs can utilize the digital signals to monitor an area.

Most video capture boards include a digital signal processor (“DSP”) and associated built-in software control processes, referred to as firmware. To process incoming video image data, the video capture board can include additional software processes corresponding to the specific DSP and firmware combination. In one aspect, most video capture cards include software processes that allow the video capture board to collect video data. Generally described, video data is collected in various video formats as a sequence of still images, called frames. The rate and speed at which video is collected is measured in the number of frames per second (“FPS”). In another aspect, the video capture board can include software processes that convert the incoming analog image data into a digital format. Additionally, these software processes can also compress, filter, or otherwise further process the video image.

Most conventional video capture boards combine the processes of capturing incoming video signals and processing of video frames into one logical unit of work implemented by the DSP. However, the processing component of the data can often demand more processing resources than the video capturing component. Accordingly, the utility of most conventional video capture boards is constrained by the functional linkage of the collection and processing components. As a result, the amount of video data that can be collected by a video capture board at a given point in time is contingent on the amount of captured video data already being processed by the DSP.

Thus, there is a need for a system and method that provides for the asynchronous collection and management of video data.

### SUMMARY OF THE INVENTION

A system and method for asynchronously processing video images are provided. A video processing computing device includes one or more video capture boards in communication with a number of image capture devices, such as video cameras. The video image processing computing device includes a video collection application that is operable to instruct the video capture board to acquire video data and store the data in a shared memory area. The video processing computing device also includes a video processing application that is operable to acquire the stored video from the shared memory area and process the video data. By utilizing a shared memory area, the video collection application and the video processing application can process data asynchronously.

In accordance with an aspect of the present invention, a method for asynchronously processing video data is provided. The method may be implemented in a system including a least one image capture device generating video data. In accordance with the method, a collection process obtains video data and stores the video data in a shared memory. The collection process then repeats the collection process. Additionally, a processing process obtains the video data from the shared memory and processes the video data. The processing process then repeats the processing process. Still further, the collection process can repeat the collection process without requiring the processing process.

In accordance with another aspect of the present invention, a system for processing video data is provided. The system includes at least one image capture device for producing video images. The system also includes a video collection component for receiving video image data from the video capture device and storing the video image data in a shared memory. The system further includes a video processing component for obtaining video image data from the shared memory and for processing the video image data. The video collection component and the video processing component are asynchronous.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram depicting an illustrative architecture for a video processing computing device in communication with multiple image capture devices in accordance with the present invention;

FIG. 2 is a flow diagram of a video data collection routine implemented by a video processing computing device in accordance with the present invention; and

FIG. 3 is a flow diagram of a video data processing routine implemented by a video processing computing device in accordance with the present invention.

### DETAILED DESCRIPTION OF THE PREFERRED EMBODIMENT

Generally described, the present invention relates to a system and method for asynchronously collecting and processing video data generated by one or more image capture devices. More specifically, the present invention will be described in relation to the capturing and processing of frame-based video processing. However, one skilled in the relevant art will appreciate that the present invention may be applicable to other types of video processing, including, but not limited to, streaming video processing and still image video processing. Accordingly, the disclosed embodiments should not be construed as limiting.

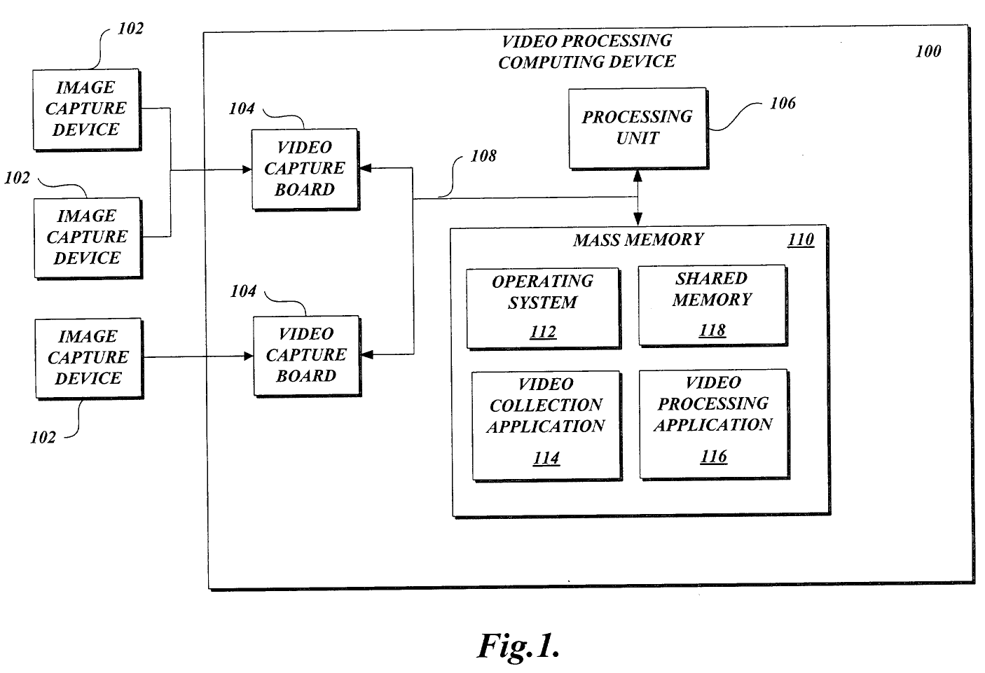

With reference to FIG. 1, an illustrative architecture for a video processing computing device 100 formed in accordance with the present invention will be described. Those of ordinary skill in the art will appreciate that the video processing computing device 100 may include many more components than those shown in FIG. 1. However, it is not necessary that all of the generally conventional components be shown in order to disclose an illustrative embodiment for practicing the present invention.

As shown in FIG. 1, a number of image capture devices 102 are in communication with the video processing computing device 100. The image capture devices 102 can include video image capture devices and still image capture devices. Additionally, the image capture devices may be connected to the video processing computing device via a variety of communication media such as wired and wireless communication media. Additionally, the image capture devices 102 may be connected to the video processing computing device 100 via a local area network (“LAN”) or a wide area network (“WAN”).

Each image capture device 102 corresponds to at least one video capture board 104. In an illustrative embodiment of the present invention, each video capture board 104 is a printed circuit board attached to a computer's operating system for expanding a computer's capabilities, generally known as an expansion board. The video capture board 104 can include a digital signature processor, a memory, and software components for controlling the digital signature processor. Additionally, the video capture board 104 can include one or more device drivers stored in the memory for communicating with various image capture devices 102. Each video capture board 104 may communicate with other components via a communication bus 108 using standards such as peripheral component interconnect (“PCI”) or industry standard architecture (“ISA”). In one embodiment, the image capture devices 102, the video capture board 104, the video processing device 100, and the shared memory area 118 are each a physically separate component of the system.

The video processing computing device 100 also includes a central processing unit 106 and a mass memory 110, which communicate via the communication bus 108. The mass memory 110 generally comprises a random access memory (“RAM”), a read-only memory (“ROM”), and a permanent mass storage device, such as a hard disk drive, tape drive, optical drive, optical drive, floppy disk drive, or any combination thereof. The mass memory stores an operating system 112 for controlling the operation of the video processing computing device 100. In an illustrative embodiment of the present invention, the video processing computing device 100 is a server computing device. Accordingly, the operating system 112 may comprise a general-purpose server operating system as is known to those skilled in the art, such as UNIX, LINUX™, or Microsoft WINDOWS NT®. Alternatively, the operating system 112 may comprise an operating system corresponding to the specific type of computing device being utilized. The mass memory 1 10 also stores programs for controlling the collection of video data and the processing of the collected video data. More specifically, the mass memory 110 stores a video collection application 114 operable to interface with the video capture boards 104 to capture video images in accordance with the present invention. The mass memory 110 also stores a video processing application 116 operable to process captured video images in accordance with the present invention.

The video collection application 114 and the video processing application 116 comprise computer-executable instructions which, when executed by the video processing computing device 100, capture and process video images as will be explained in greater detail below. Additionally, the mass memory 110 includes a shared memory component 118 for storing captured video images as will be explained in greater detail below. It will be appreciated that these components may be stored on a computer-readable medium and loaded onto the computing device 100 using a drive mechanism associated with the computer-readable medium, such as a floppy disk drive, CD-ROM, DVD-ROM drive, or network interface.

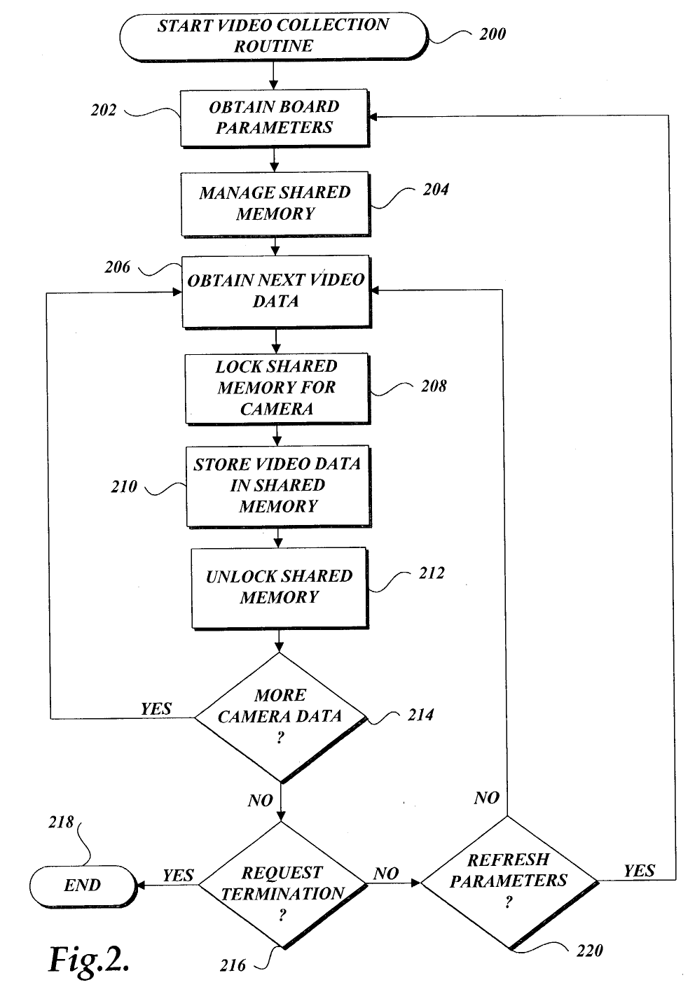

With reference now to FIG. 2, a routine 200 implemented by the video collection application 114 of the video processing computing device 100 for collecting video data will be explained. In accordance with the present invention, the video collection application 114 interacts with the video capture boards 104 using commands and logic specific to each video capture board. At block 202, the video collection application 114 obtains parameter data for the video capture board 104. In an illustrative embodiment of the present invention, the video capture board parameters include the number of image capture devices 102 attached to the video capture board 104 and the data required to configure the video capture board for use with each of the attached image capture devices 102. The configuration data can include manufacturer-specific communication protocol information. The video collection application 114 can retrieve the parameter data from a database including parameter information for each attached video capture device 104. The database may be stored locally or accessed remotely via a communication network.

At block 204, the video collection application 114 manages a shared memory area 118 for each image capture device 102. In an illustrative embodiment of the present invention, the shared memory area 118 is formatted to convey pertinent information about the frame, a locking mechanism to control access to the frame data, and a variably-sized area for the video frame data. To manage the video image data stored in the shared memory 118, a common naming convention for each image capture device 102 is utilized. In an illustrative embodiment of the present invention, the input channel on the video capture board 104 used for the image capture device 102 is used to name (identify) the shared memory area 118 for the particular image capture device 102. In a further aspect of the present invention, this naming convention is common to the video collection application 114 and the video processing application 116.

With continued reference to FIG. 2, once the shared memory areas have been allocated, the collector formats the video capture board 104 and begins a frame collection process. At block 210, video data is collected. In an illustrative embodiment of the present invention, for each image capture device 102 attached to the video capture board 104, the video collection application 114 will instruct the video capture board's DSP to collect video data from the appropriate input channel on the video capture board. At block 208, video collection application 114 locks the shared memory area 118 for the current video capture device 102. Locking the shared memory area 118 will prevent any other processes from creating, modifying, or reading data stored in the shared memory area 118 and associated with the particular image capture device 102. In an illustrative embodiment of the present invention, a lock flag is built into the frame record structure that is stored in the shared memory area 118. All programs check for this flag and if found it indicates that the shared memory space is locked.

At block 210, the video collection application 114 transfers the collected frame data into the appropriate shared memory segment 118. At block 212, the video collection application 114 unlocks the shared memory 118. In an illustrative embodiment of the present invention, the video collection application 114 attempts to unlock the shared memory 118 immediately upon transferring the data to make the data available to other processes. At decision block 214, a test is conducted to determine whether there are additional image capture devices 102 generating data to the image capture board 104. If there are more image capture devices 102, the routine 200 returns to block 206.

If no additional image capture device data is present, at decision block 216, a test is conducted to determine whether the collection process should be terminated. In an illustrative embodiment of the present invention, the collection process may be terminated by the video processing computing device 100 after expiration of a condition (e.g., specific time limit, by a user request at the video processing computing device 100 and/or by a signal from the image capture devices 102). If the collection process should be terminated, the routine 200 terminates at block 218. Alternatively, if the collection should not be terminated, at decision block 220, a test is conducted to determine whether the video capture board's 104 parameters have been refreshed. If the parameters have not been refreshed, the routine 200 returns to block 206 to obtain the next frame of video data. If the parameters have been refreshed, the routine 200 returns to block 202. Accordingly, the video collection routine 200 may continue to independently collect image data until terminated.

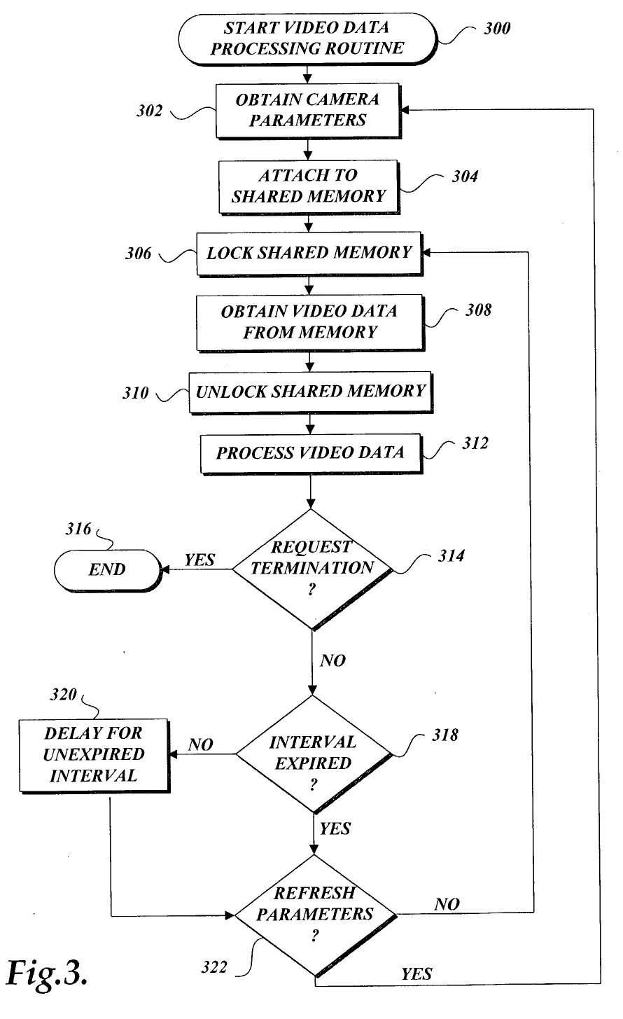

The second component of the present invention is a video processor. A flow diagram representative of the video processor 300 is shown in FIG. 3. A video processor performs the actual manipulations of bits in RAM that correspond to pixels on a display. The processor works in a variety of formats including 8-bit gray scale, or 24-bit red, green, blue color (“RGB”).

Referring now to FIG. 3, a video processor routine 300 implemented by the video processing application 116 of the video processing computing device 100 is provided. At step 302, the video processing application 116 obtains image capture device parameters. In an illustrative embodiment of the present invention, the image capture device parameters can include data regarding the format of the incoming video data. The video processing application 116 may obtain the image capture device parameters from a database. The database may be locally stored or remotely accessed via a communication network.

At block 304, the video processing application 1 16 attaches to the shared memory 118. At block 30 6, the video processing application 116 locks the shared memory 118 for the particular video capture device 118. Similar to the video collection routine 200 (FIG. 2), in an illustrative embodiment of the present invention, a lock flag is built into the frame record structure that is stored in the shared memory area 118. All programs check for this flag and if found, indicates that the shared memory space is locked. At block 308, the video processing application 116 obtains video data corresponding to the image capture device 102 from the shared memory segment 118. At block 310, the video processing application 116 unlocks the shared memory segment 118.

At block 312, the video processing application 116 processes the video data. In an illustrative embodiment of the present invention, processing the video data can include encoding raw video into a standard format. For example, the video processing application 116 can encode all video data into 8-bit gray scale or 24-bit RGB. Additionally, processing the video data can include encrypting the data, compressing the data for transmission, motion sensitivity processing, filtering, image labeling, time stamping, watermarking, and the like. One skilled in the relevant art will appreciate that additional or alternative processing are within the scope of the present invention.

At decision block 314, a test is conducted to determine whether a termination request has been obtained. If a termination request has been obtained, the routine 300 terminates at block 316. In an illustrative embodiment of the present invention, the termination request may be generated by the video processing application 116, another component of the video processing computing device 100 (such as through a user or another software component), or by another computing device in communication with the video processing computing device 100.

If a termination request has not been obtained, at decision block 318, a test is conducted to -determine whether a time interval has expired. In an illustrative embodiment of the present invention, the time interval may be utilized to allow the video processing application 116 to wait a threshold amount of time between image processing tasks. The time interval may be pre-determined, set by a system administrator, or dynamically adjusted depending on the utilization of the system resources for the video processing computing device 100.

If the time interval has not expired, at block 320, the video processing application 116 enters a delay until the time interval expires. Once the time interval has expired, at decision block 322, a test is conducted to determine whether the image capture device parameters have been refreshed. If the image capture device parameters have not been refreshed, the routine 300 returns to block 306 to process additional frame data in the shared memory 118. If the image capture device parameters have been refreshed, the routine 300 returns to block 302. Accordingly, the routine 300 will continue to independently process image data until terminated.

In accordance with the present invention, video data management may be created for a number of image capture boards 104 associated with a video processing computing device 100. By utilizing a shared memory area 118, the video collection processing application 114 and the video processing application 116 transmit data, but are linked asynchronously. Accordingly, each application may function independently.

While illustrative embodiments of the invention have been illustrated and described, it will be appreciated that various changes can be made therein without departing from the spirit and scope of the invention.

The embodiments of the invention in which an exclusive property or privilege is claimed are defined as follows:

1. In a system including a least one image capture device generating video data, a method for asynchronously processing video data, the method comprising:
(a) obtaining, by a collection process, video data corresponding to the image capture device;
(b) storing, by the collection process, the video data in a shared memory;
(c) repeating, by the collection process, (a) and (b);
(d) obtaining, by a processing process, the video data from the shared memory;
(e) processing, by the processing process, the video data; and
(f) repeating, by the processing process, (d) and (e);
wherein the collection process repeats (a) and (b) without requiring the completion of (e) and (f) by the processing process.

2. The method as recited in claim 1, wherein the collection process repeats (a) and (b) without requiring the initiation of (e) and (f) by the processing process.

3. The method as recited in claim 1, wherein the collection process repeats (a) and (b) without requiring the completion of (e) and (f) by the processing process.

4. The method as recited in claim 1, wherein obtaining the video data by the collection process includes obtaining parameters corresponding to a video board providing the video data and obtaining the video data according to the video board parameters.

5. The method as recited in claim 1, wherein storing the video data in shared memory by the collection process includes:
allocating a location in the shared memory corresponding to a video capture device providing the video data;
locking the allocated location in the shared memory corresponding to the video capture device;
obtaining at least one frame of video data from the video capture device;
storing the at least one frame of video data from the video capture device; and
unlocking the allocated location in the shared memory corresponding to the video capture device.

6. The method as recited in claim 5, wherein obtaining the video data from the shared memory includes:
locking the allocated location in the shared memory corresponding to the video capture device;
obtaining at least one frame of video data from the allocated location in the shared memory corresponding to the video capture device;
deleting the at least one frame from the allocated location in the shared memory corresponding to the video capture device; and
unlocking the allocated location in the shared memory corresponding to the video capture device.

7. The method as recited in claim 1, wherein the processing process repeats (e) and (f) without requiring the repeat of (a) and (b) by the collection process.

8. The method as recited in claim 1, wherein processing the video data by the processing process includes processing selected from the group consisting of encoding video data, encrypting video data, compressing video data, transmitting video data, filtering video data, image labeling video data, time stamping video data, watermarking video data, and motion sensitivity processing video data.

9. The method as recited in claim 1, wherein the system includes two or more video capture devices and wherein the shared memory stores video data from the two or more image capture devices in an allocated location corresponding to each of the two or more video capture devices.

10. A computer-readable medium having computer-executable instructions operable for performing the method recited in claim 1.

11. A computer system having a processor, a memory and an operating environment, the computer system operable to perform the method recited in claim 1.

12. A system for processing video data, the system comprising:
at least one image capture device for producing video images;
a video collection component for receiving video image data from the video capture device and storing the video image data in a shared memory; and
a video processing component for obtaining video image data from the shared memory and for processing the video image data;
wherein the video collection component and the video processing component are asynchronous.

13. The system as recited in claim 12 further comprising a video capture board corresponding to the at least one video capture device, wherein the video capture board digitally processes incoming video data from the image capture device.

14. The system as recited in claim 13, wherein the system includes two or more image capture devices and wherein the video capture board digitally processes incoming video data from the two or more image capture devices.

15. The system as recited in claim 14 further comprising two or more video capture devices for processing incoming data from the two or more image capture devices.

16. The system as recited in claim 12, wherein the video collection application allocates location in the shared memory corresponding to a video capture device providing the video data, locks the allocated location in the shared memory corresponding to the video capture device, obtains at least one frame of video data from the video capture device, stores the at least one frame of video data from the video capture device, and unlocks the allocated location in the shared memory corresponding to the video capture device.

17. The system as recited in claim 16, wherein the video processing component locks the allocated location in the shared memory corresponding to the video capture device, obtains at least one frame of video data from the allocated location in the shared memory corresponding to the video capture device, deletes the at least one frame from the allocated location in the shared memory corresponding to the video capture device, and unlocks the allocated location in the shared memory corresponding to the video capture device.

18. The system as recited in claim 12, wherein the video collection component repeats obtaining and storing video image data without requiring an initiation of the retrieval and storage of the stored video image data by the video storage application.

19. A system for processing video data, the system comprising:
at least one image capture device for producing video images;
video collection means for collecting and storing video image data in a shared memory; and
video processing means for asynchronously processing the video image data in the shared memory.

20. The system as recited in claim 19 further comprising a video capture board corresponding to the at least one video capture device, wherein the video capture board digitally processes incoming video data from the image capture device.

21. The system as recited in claim 20, wherein the system includes two or more image capture devices and wherein the video capture board digitally processes incoming video data from the two or more image capture devices.

22. The system as recited in claim 21 further comprising two or more video capture devices for processing incoming data from the two or more image capture devices.

23. The system as recited in claim 19, wherein the video collection means allocates location in the shared memory corresponding to a video capture device providing the video data, locks the allocated location in the shared memory corresponding to the video capture device, obtains at least one frame of video data from the video capture device, stores the at least one frame of video data from the video capture device, and unlocks the allocated location in the shared memory corresponding to the video capture device.

24. The system as recited in claim 23, wherein the video processing means locks the allocated location in the shared memory corresponding to the video capture device, obtains at least one frame of video data from the allocated location in the shared memory corresponding to the video capture device, deletes the at least one frame from the allocated location in the shared memory corresponding to the video capture device, and unlocks the allocated location in the shared memory corresponding to the video capture device.

25. The system as recited in claim 19, wherein the video collection means repeats obtaining and storing video image data without requiring an initiation of the retrieval and storage of the stored video image data by the video storage application.
